(19) United States
(12) Patent Application Publication
(10) Pub. No.: US 2021/0286582 A1
(43) Pub. Date: Sep. 16, 2021

(54) Display Device

(71) Applicants: Kim Samuel, Bronx, NY (US); Carl Samuel, JR., Bronx, NY (US)

(72) Inventors: Kim Samuel, Bronx, NY (US); Carl Samuel, JR., Bronx, NY (US)

(21) Appl. No.: 17/197,931

(22) Filed: Mar. 10, 2021

Related U.S. Application Data
(60) Provisional application No. 62/988,443, filed on Mar. 12, 2020.

(51) Int. Cl. G06F 3/16; A47G 7/06; G09G 3/00; F21V 33/00; F21V 23/04

(52) U.S. Cl. CPC G06F 3/16; A47G 7/06; G09G 3/03; H04R 1/028; F21V 23/0442; G09G 2320/0666; G09G 2354/00; F21V 33/0028

(57) ABSTRACT

A display device for holding flowers and displaying pictures, videos, or the like, with voice control and lights includes a structure having a base, a medial section, and a top section. The base, medial section, and top section are separably coupled together to define the structure. A display screen is coupled to and faces outwardly from said structure.

### CROSS-REFERENCE TO RELATED APPLICATIONS

I hereby claim the benefit under 35 U.S.C. Section 119(e) of U.S. Provisional application 62/988,443 filed on Mar. 12, 2020.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to display devices and more particularly pertains to a new display device with separable sections to permit customized appearance of the device for displaying pictures, videos, or the like, with voice control and lights.

### (2) Description of Related Art Including Information Disclosed Under 37 CFR 1.97 and 1.98

The prior art relates to display devices.

### BRIEF SUMMARY OF THE INVENTION

An embodiment of the disclosure meets the needs presented above by generally comprising a structure having a base, a medial section, and a top section. The base, medial section, and top section are separably coupled together to define the structure. A display screen is coupled to and faces outwardly from said structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front perspective view of a display device according to an embodiment of the disclosure.

FIG. 2 is a front view of an embodiment of the disclosure.

FIG. 3 is a rear view of an embodiment of the disclosure.

FIG. 4 is an exploded front view of an embodiment of the disclosure.

FIG. 5 is a top front side perspective view of a medial section of an embodiment of the disclosure.

FIG. 6 is an exploded view of the medial section of an embodiment of the disclosure.

FIG. 7 is a bottom front side perspective view of the medial section of an embodiment of the disclosure.

FIG. 8 is a schematic view of an embodiment of the disclosure.

FIG. 9 is a top front side perspective view of an alternative embodiment of the disclosure.

FIG. 10 is a front view of the alternative embodiment of the disclosure.

FIG. 11 is a top front side perspective view of a medial section of the alternative embodiment of the disclosure.

FIG. 12 is a front exploded view of an embodiment of the disclosure.

### DETAILED DESCRIPTION OF THE INVENTION

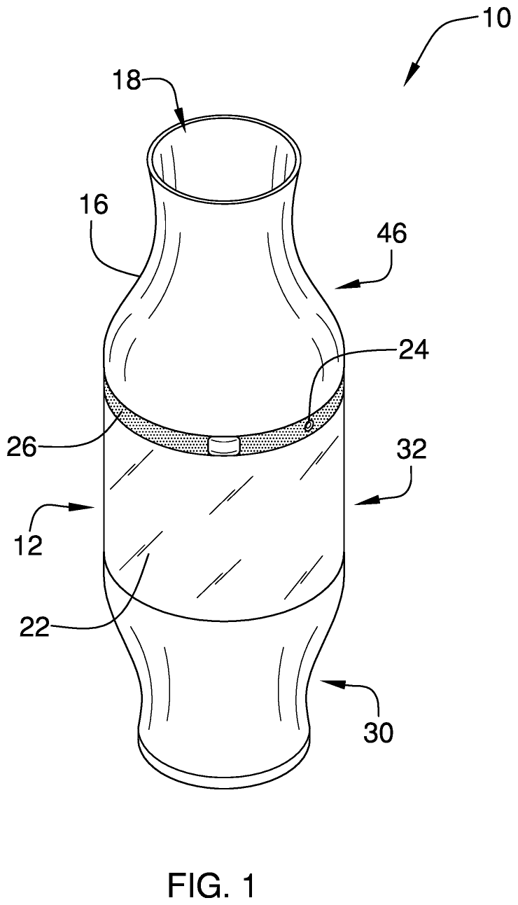

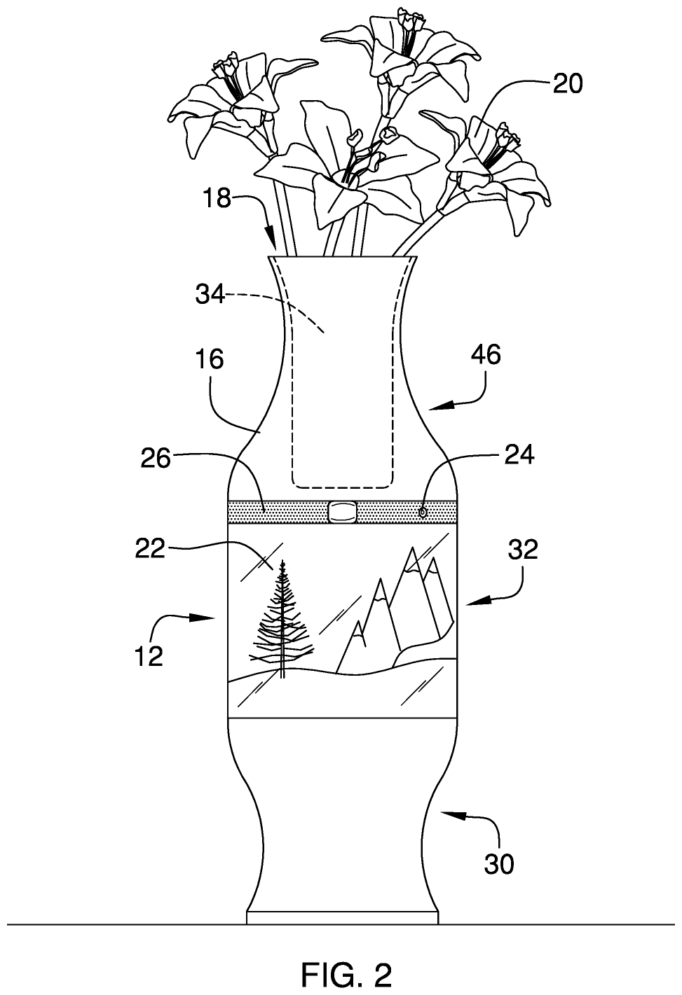

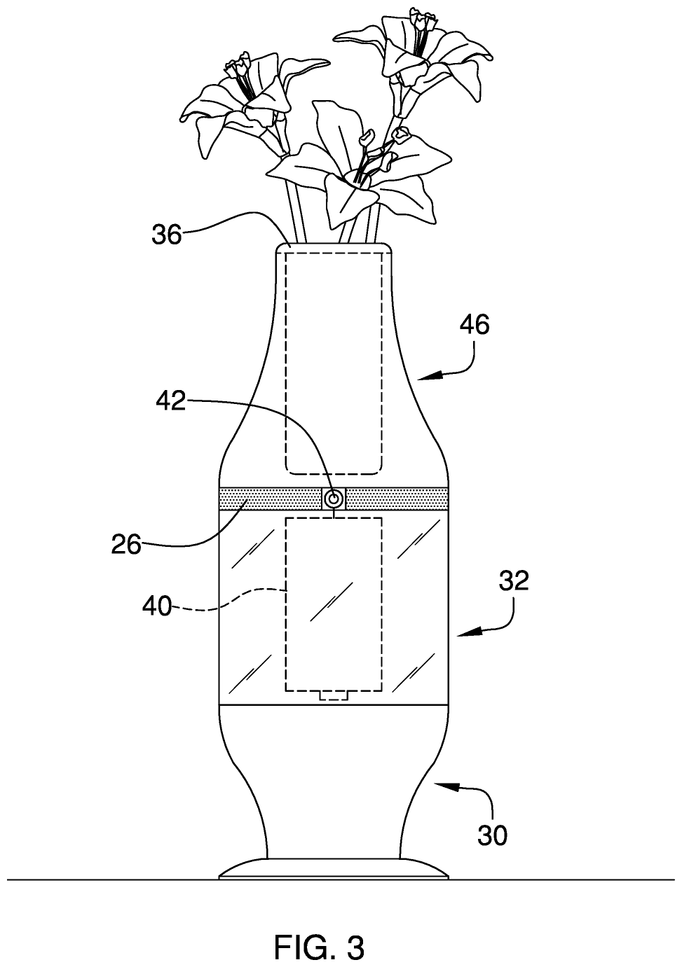

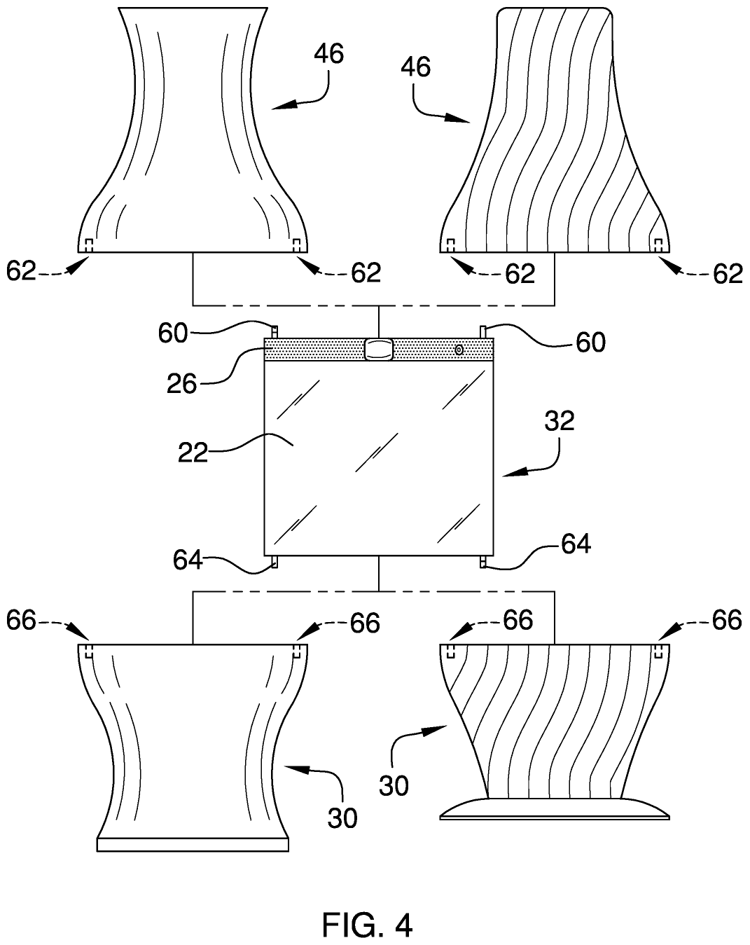

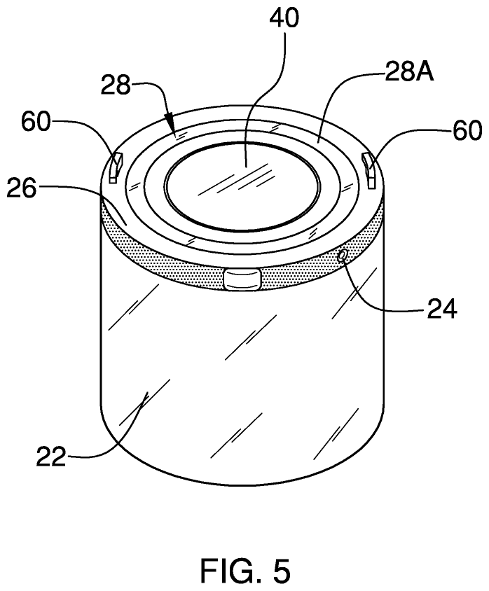

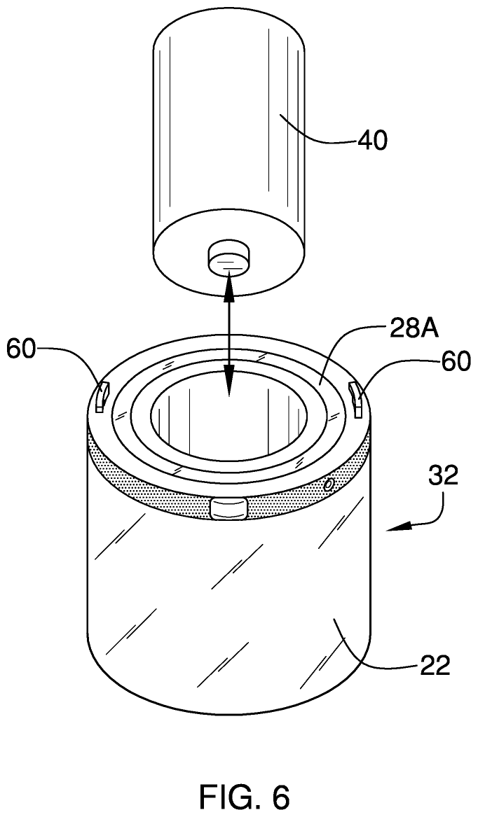

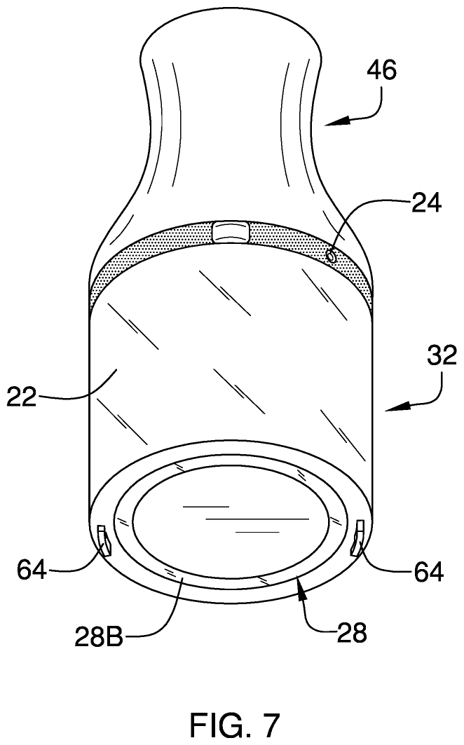

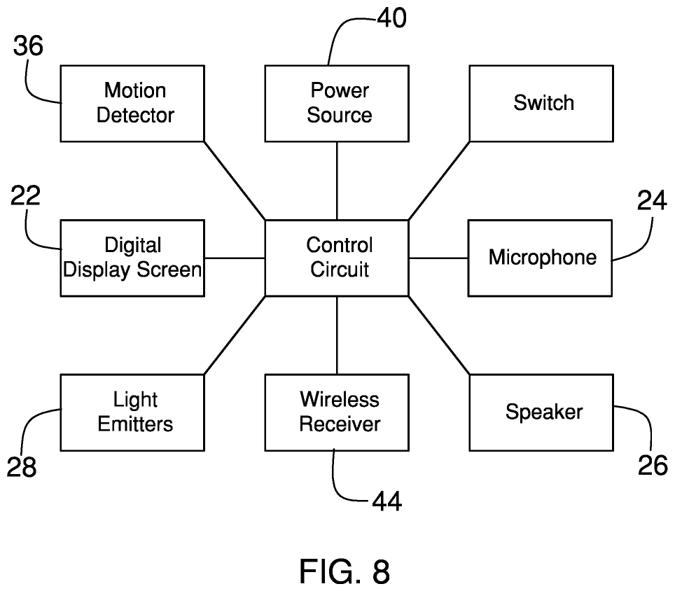

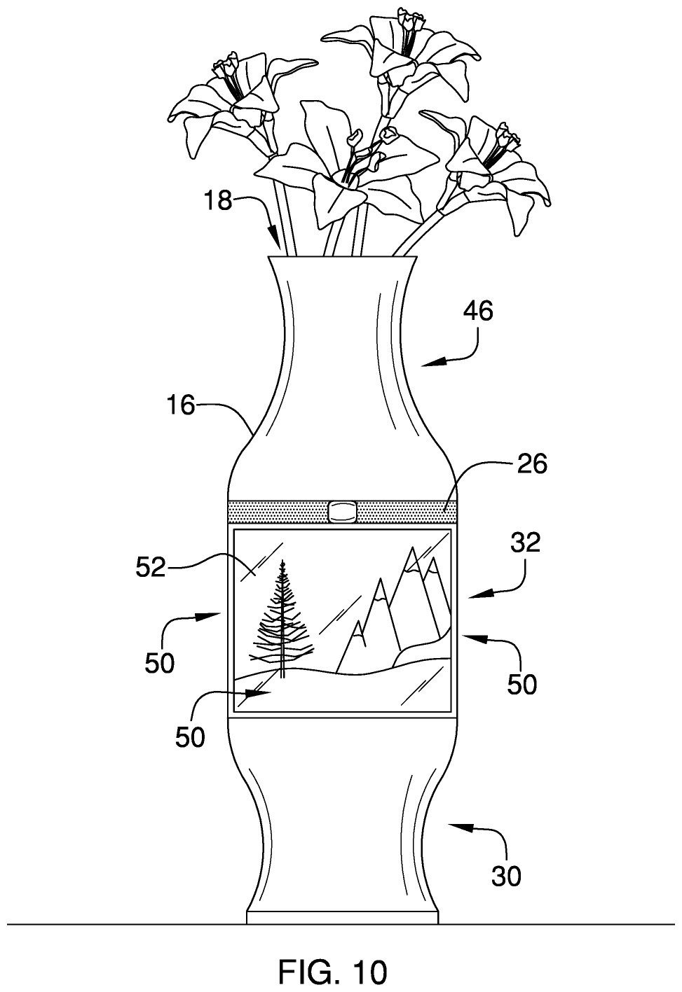

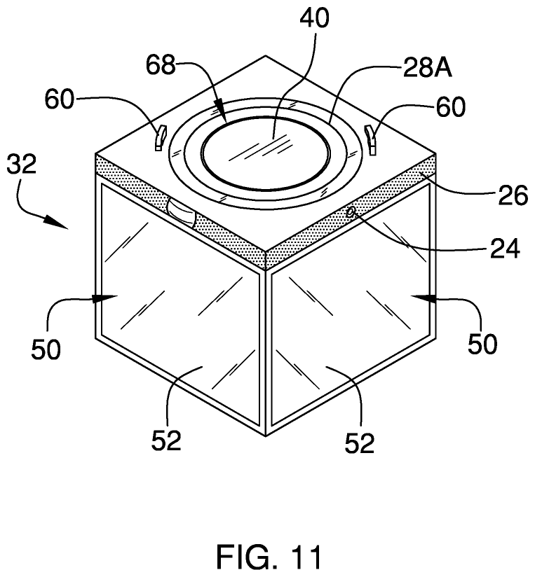

With reference now to the drawings, and in particular to FIGS. 1 through 12 thereof, a new structure devices embodying the principles and concepts of an embodiment of the disclosure and generally designated by the reference numeral 10 will be described.

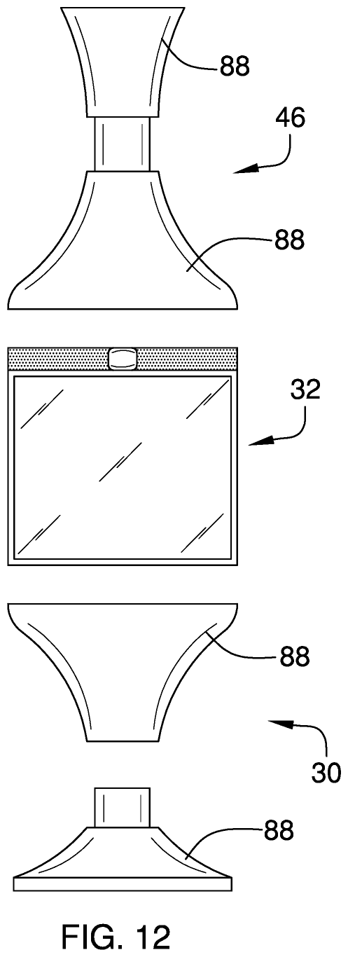

As best illustrated in FIGS. 1 through 12, the display device 10 generally comprises a structure 12 having a base 30, a medial section 32, and a top section 46 separably coupled together to define the structure 12. The top section 46 may be a peripheral wall 16 extending upwardly from the medial section 32 to define a void 18 configured to hold flowers or the like wherein the structure 12 can function as a vase. A removable and/or replaceable vessel 34 may be positioned in the void 18 to hold the flowers 20 facilitating changing of the flowers 20 without having to move the entire structure 12. Alternatively, the top section 46 may be decorative such as a holiday display, tree, etc. The top section 46 and/or the base 30 may be a unitary piece or, as exemplified in FIG. 12, have separable and interchangeable subsections 88. Although one set of subsections 88 is shown, it would be understood that each subsection 88 could be shaped differently and that not all subsections 88 are interchangeable. The intent is that a variety of subsections 88 may be used consistent with the core concept of the present invention. The subsections 88 may be of different shapes and styles to allow for mixing and matching or customization as desired. The base 30 is removable from the medial section 32 allowing for interchanging of the base 30 for different shapes, designs, colors, or the like.

A pair of upper pegs 60 is coupled to the medial section 32. The pair of upper pegs 60 extends upwardly away from a top of the medial section 32. Each of a pair of upper peg wells 62 extends into the top section 46. The pair of upper peg wells 62 is positioned and sized to be complementary to the pair of upper pegs 60 wherein the top section 46 is positionable on the medial section 32 such that the upper pegs 60 are inserted into the upper peg wells 62. Thus, the upper pegs 60 inhibit movement of the top section 46 on the medial section 32. Each of a pair of lower pegs 64 is coupled to the medial section 32. The pair of lower pegs 64 extends downwardly away from a bottom of the medial section 32. Each of a pair of lower peg wells 66 extends into the base 30. The pair of lower peg wells 66 is positioned and sized to be complementary to the pair of lower pegs 64 wherein the medial section 32 is positionable on the base 30 such that the lower pegs 64 are inserted into the lower peg wells 66. Thus, the lower pegs 64 inhibit movement of the medial section 32 on the base 30. Alternatively, conventional connections may be made using magnets, clips, or other conventional fasteners.

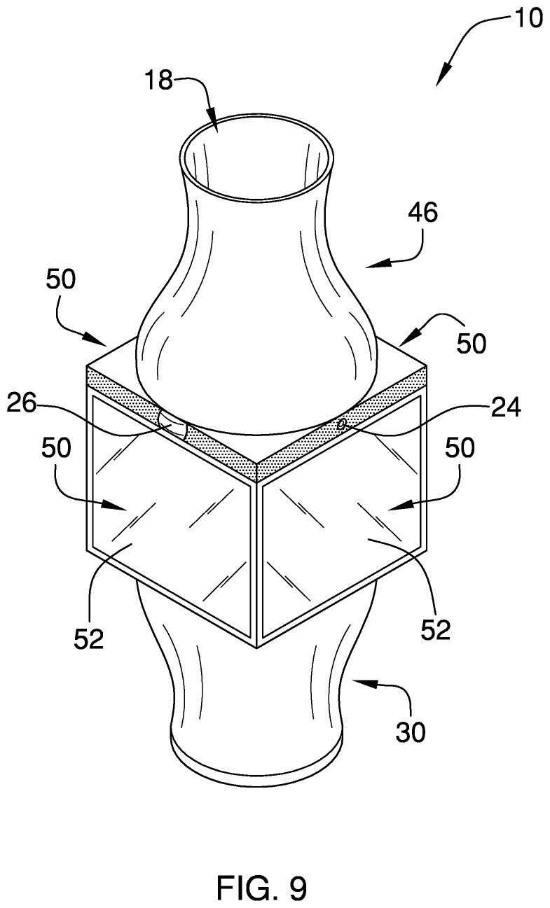

A display screen 22, as shown in FIGS. 1 through 7, is coupled to and faces outwardly from the structure 12. The display screen 22 may be positioned facing outwardly from the medial section 32. The medial section 32, as shown by example in FIGS. 9 through 11, may be a geometric shape having a plurality of planar faces 50 with the display screen 22 being formed by a plurality of planar displays panels 52 positioned on one or more of the faces 50. As shown in FIGS. 1 through 7, the display screen 22 may also be curved to extend partially or fully around the medial section 32. The display screen 22 may be a conventional type of screen of the same type used in phones, tablets, table top displays used for home device control and internet connectivity, or the like.

A microphone 24 is coupled to the structure 12. The microphone 24 is operationally coupled to the display screen 22 wherein images displayed on the display screen 22 are controllable by audible operational commands. The source of visual images, either still or moving, may be through electronic memory incorporated into the device 10 or through internet, wifi, personal access network, or other connectivity to an external source. A speaker 26 is coupled to the structure 12 wherein the speaker 26 is configured for playing sounds such as audio associated with video on the display screen 22, songs, streaming content from an extrinsic source, or the like. The speaker may be positioned immediately above the display screen 22 and extending around the medial section 32 to project sound outwardly fully around the structure 12. The speaker 26 may be a single audio production device or may incorporate multiple components operationally combined to produce the audio broadcast. The speaker 26 may alternatively be positioned anywhere on the device 10 using either wired connection or wireless connection to an audio source. The microphone 24 may be positioned with or incorporated into the speaker 26. A motion detector 36 may also be coupled to and incorporated into the structure 12. The motion detector 36 is operationally coupled to the display screen 22 and/or any of the other components discussed below to selectively activate the described functions when motion is detected by the motion detector 36.

A light 28 may be coupled to the structure 12. The light 28 is controllable by audible commands through the microphone 24 or may be controlled by operational controls incorporated into the structure 12 or display screen 22. The operational controls may be buttons, switches, sliders, touchscreen on the device 10 or incorporated into a wireless device such as a smartphone, or any combination thereof. The light 28 may be one of a plurality of lights 28 coupled to the structure 12. The plurality of lights 28 includes an upwardly facing light 28A and a downwardly facing light 28B. The upwardly facing light 28A is inset from an outer perimeter of the medial section 32 on a top surface 38 of the medial section 32. The upwardly facing light 28A projects light towards the peripheral wall 16 which may be constructed using a translucent or transparent material such that the upwardly facing light 28A produces a luminous effect in and/or around the peripheral wall. The downwardly facing light 28B is similarly structured for producing a luminous effect in the base 30. A color of the lights 28 may be selectable either in groups or individually for patterns. The light 28 may be controlled by use of the microphone 24, a conventional remote control, a smartphone application, or the like.

A replaceable battery 40 is electrically coupled to the display screen 22. The battery 40 may be charged through a port 42 positioned on the structure 12, specifically on the medial section 32. The battery 40 may be cylindrical and positioned centrally in a battery well 68 in the medial section 32 to provide even weight distribution around a central vertical axis of the structure 12 to facilitate balancing and stability of the structure 12. The device 10 may also use a built in battery of any shape. The device 10 may also be powered by a wired connection through a power port or the like.

A receiver 44 is coupled to the structure 12, typically in the medial section 32. The receiver 44 is in operational communication with the display screen 22 and any of the other components described herein such that the display screen 22 and other components are configured to be controlled remotely by an extrinsic electronic device such as a cellular phone through an app.

In use, the desired design for the structure 12 is determined by connection of a selected base 30, medial section 32, and top section 46. The operational components such as the speaker 26, microphone 24, display screen 22, etc. may be incorporated exclusively into the medial section 32 such that the base 30 and top section 46 can be replaced without influencing function of the operational components. The invention further contemplates that the medial section 32 may be integrally and non-removably coupled to either one of the base 30 and top section 46 to allow for interchanging of just one of the base 30 and the top section 46 as opposed to both being customizable and/or replaceable. Control of the device 10 may be done through exclusively voice control through the microphone 24, a remote control, or controls on the device 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A display device comprising:
a structure having a base, a medial section, and a top section, said base, medial section, and top section being separably coupled together to define said structure; and
a display screen, said display screen being coupled to and facing outwardly from said structure.

2. The display device of claim 1, further comprising a microphone coupled to said structure, said microphone being operationally coupled to said display screen wherein images displayed on said display screen are controllable by audible operational commands.

3. The display device of claim 1, further comprising a speaker coupled to said structure wherein said speaker is configured for playing sounds.

4. The display device of claim 2, further comprising a light coupled to said structure, said light being controllable by audible commands through said microphone.

5. The display device of claim 4, further comprising said light being one of a plurality of lights coupled to said structure, said plurality of lights including upwardly facing lights and downwardly facing lights coupled to said medial section.

6. The display device of claim 5, further comprising said plurality of lights being LED lights wherein a color of said plurality of lights is selectable.

7. The display device of claim 1, further comprising a replaceable battery being electrically coupled to said display screen and positioned in said medial section.

8. The display device of claim 1, further comprising a receiver coupled to said structure, said receiver being in operational communication with said display screen wherein said display screen is configured to be controlled by an extrinsic electronic device.

9. The display device of claim 1, further comprising:
a pair of upper pegs coupled to said medial section, said pair of upper pegs extending upwardly away from a top of said medial section; and
a pair of upper peg wells, each of said upper peg wells extending into said top section, said pair of upper peg wells being positioned and sized to be complementary to said pair of upper pegs wherein said top section is positionable on said medial section such that said upper pegs are inserted into said upper peg wells wherein said upper pegs inhibit movement of said top section on said medial section.

10. The display device of claim 1, further comprising:
a pair of lower pegs coupled to said medial section, said pair of lower pegs extending downwardly away from a bottom of said medial section; and
a pair of lower peg wells, each of said lower peg wells extending into said base, said pair of lower peg wells being positioned and sized to be complementary to said pair of lower pegs wherein said medial section is positionable on said base such that said lower pegs are inserted into said lower peg wells wherein said lower pegs inhibit movement of said medial section on said base.

11. The display device of claim 7, further comprising:
a battery well in said medial section, said battery well being cylindrical and concentric with a central vertical axis of said medial section; and
said replaceable battery being complementary in shape to said battery well

12. The display device of claim 5, further comprising:
said upwardly facing light being coupled to said medial section; and
said top section being light transmitting and aligned with said upwardly facing light such that said top section is luminous when said upwardly facing light is on.

13. The display device of claim 5, further comprising:
said downwardly facing light being coupled to said medial section; and
said base being light transmitting and aligned with said downwardly facing light such that said base is luminous when said downwardly facing light is on.

14. The display device of claim 5, further comprising:
said upwardly facing light being coupled to said medial section;
said top section being light transmitting and aligned with said upwardly facing light such that said top section is luminous when said upwardly facing light is on;
said downwardly facing light being coupled to said medial section; and
said base being light transmitting and aligned with said downwardly facing light such that said base is luminous when said downwardly facing light is on.

15. The display device of claim 13, further comprising said upwardly facing light being annular.

16. The display device of claim 14, further comprising said downwardly facing light being annular.

17. A display device comprising:
a structure having a base, a medial section, and a top section, said base, medial section, and top section being separably coupled together to define said structure;
a display screen, said display screen being coupled to and facing outwardly from said structure;
a microphone coupled to said structure, said microphone being operationally coupled to said display screen wherein images displayed on said display screen are controllable by audible operational commands;
a speaker coupled to said structure wherein said speaker is configured for playing sounds;
a plurality of lights coupled to said structure, each said light being controllable by audible commands through said microphone, said plurality of lights including an upwardly facing light and a downwardly facing light, each light of said plurality of lights being a light emitting diode light wherein a color of each of said lights of said plurality of lights is selectable, said upwardly facing light being coupled to said medial section, said top section being light transmitting and aligned with said upwardly facing light such that said top section is luminous when said upwardly facing light is on, said downwardly facing light being coupled to said medial section, said base being light transmitting and aligned with said downwardly facing light such that said base is luminous when said downwardly facing light is on, said upwardly facing light being annular, said downwardly facing light being annular;
a replaceable battery being electrically coupled to said display screen and positioned in said medial section;
a receiver coupled to said structure, said receiver being in operational communication with said display screen wherein said display screen is configured to be controlled by an extrinsic electronic device;
a pair of upper pegs coupled to said medial section, said pair of upper pegs extending upwardly away from a top of said medial section;
a pair of upper peg wells, each of said upper peg wells extending into said top section, said pair of upper peg wells being positioned and sized to be complementary to said pair of upper pegs wherein said top section is positionable on said medial section such that said upper pegs are inserted into said upper peg wells wherein said upper pegs inhibit movement of said top section on said medial section;
a pair of lower pegs coupled to said medial section, said pair of lower pegs extending downwardly away from a bottom of said medial section; and
a pair of lower peg wells, each of said lower peg wells extending into said base, said pair of lower peg wells being positioned and sized to be complementary to said pair of lower pegs wherein said medial section is positionable on said base such that said lower pegs are inserted into said lower peg wells wherein said lower pegs inhibit movement of said medial section on said base; and
a battery well in said medial section, said battery well being cylindrical and concentric with a central vertical axis of said medial section, said replaceable battery being complementary in shape to said battery well.
